(19) United States
(12) Patent Application Publication
(10) Pub. No.: US 2012/0015641 A1
(43) Pub. Date: Jan. 19, 2012

(54) CONTROL SYSTEM, MOBILE TERMINAL DEVICE, CONTROLLED DEVICE, CONTROL METHOD, AND COMPUTER-READABLE NON-TRANSITORY RECORDING MEDIUM STORING CONTROL PROGRAM

(75) Inventors: Akihiro Azuma, Osaka (JP); Junichi Shirakawa, Osaka (JP); Akira Tojima, Osaka (JP)

(73) Assignee: SHARP KABUSHIKI KAISHA, Osaka-shi, Osaka (JP)

(21) Appl. No.: 13/259,230

(22) PCT Filed: Mar. 1, 2010
(86) PCT No.: PCT/JP2010/053217

§ 371 Date: Sep. 23, 2011

(30) Foreign Application Priority Data
Mar. 31, 2009 (JP) 2009-085251
Jan. 20, 2010 (JP) 2010-010076

(51) Int. Cl. H04W 88/02

(52) U.S. Cl. 455/418

(57) ABSTRACT

Provided are a control system, a mobile terminal device, a controlled device, a control method, and a computer-readable non-transitory recording medium storing a control program which are capable of reducing misoperations by a user. The mobile terminal device of the control system includes an instruction determining unit for determining specifics of an instruction based on a signal from an input unit, according to a current operating mode of either a first mode (controlled-device operating mode) or a second mode (terminal-itself operating mode), a process executing unit for executing a process corresponding to determined specifics of an instruction when in the second operating mode, a change determining unit for determining whether or not the operating mode is changed from the first mode to the second mode, and an informing process unit for performing a process of informing of a change in operating mode by at least one of vibration, light, and, sound if it is determined that a change in operating mode is made.

### TECHNICAL FIELD

The present invention relates to a control system, a mobile terminal device, a controlled device, a control method, and a control program. The present invention particularly relates to a control system including a mobile terminal device and a controlled device capable of executing a process corresponding to a control signal from the mobile terminal device, a mobile terminal device capable of controlling a controlled device, a controlled device capable of executing a process corresponding to a control signal from a mobile terminal device, and a method for and a program for controlling such a mobile terminal device and such a controlled device.

### BACKGROUND ART

In recent years, a number of mobile terminal devices, such as a mobile telephone, equipped with a remote (remote control) function for operating other equipment and devices have been proposed. Some terminal devices provide a plurality of screens (states) if a remote control application program (hereinafter also referred to as “remote app”) comes with many functions, so that functional operations corresponding to the respective screens can be performed.

Conventionally, a remote controlling device which vibrates if an inappropriate operation is made in a remote control operation, has been proposed (for example, Japanese Patent Laying-Open No. 2002-135865 (Patent Literature 1)).

Further, Japanese Utility Model Laying-Open No. 05-086387 (Patent Literature 2) discloses a video game machine having a main body which transmits a signal causing a vibrator to vibrate, thereby giving a vibrational shock to an operator.

### CITATION LIST

### Patent Literature

PTL 1: Japanese Patent Laying-Open No. 2002-135865
PTL 2: Japanese Utility Model Laying-Open No. 05-086387

### SUMMARY OF INVENTION

### Technical Problem

When a user operates an operation button while a remote app is running, usually, remote control of a targeted controlled device is performed. However, sometimes the state of the remote app may (temporarily) change depending on the type of the remote app or the type of the device to be controlled. Specifically, sometimes an assignment to the operation button may change.

A common device has a screen which changes when the state of the remote app changes in this manner. Thus, the user can notice a change in state of the app by looking at the screen.

However, usually, the user often looks away from a remote controller (mobile terminal device) when performing a remote control operation. For this reasons, if the state of the remote app of the mobile terminal device changes, the user tends to be unaware of that fact. Being unaware of the fact that the state of the remote app has changed causes a misoperation. In particular, when an object to be operated has been changed from the controlled device to the terminal itself, it is more likely to unwittingly bring the state of the terminal itself into an unintended state.

The device of Patent Literature 1 vibrates only after a button is depressed, and thus it is not one that is capable of providing an advance notification of a possible misoperation. In Patent Literature 2, it is necessary for the controlled device (main body) to entirely interpret the timing of when to cause a remote controller to vibrate, and the remote controller (mobile terminal device) cannot determine whether or not the remote controller has entered a particular state.

The present invention has been made to solve the problems as above, and an object of the present invention is to provide a control system, a mobile terminal device, a controlled device, a control method, and a control program which are capable of reducing misoperations by a user.

### Solution to Problem

A control system according to an aspect of the present invention is a control system including: a mobile terminal device; and a controlled device capable of communicating with the mobile terminal device. The mobile terminal device includes: input means for accepting an instruction; first determining means for determining specifics of an instruction based on a signal from the input means, according to a current operating mode of either a first mode controlling the controlled device or a second mode performing a process for the mobile terminal device; first communication means for transmitting a control signal corresponding to determined specifics of an instruction, to the controlled device when in the first mode; first process executing means for executing a process corresponding to determined specifics of an instruction when in the second mode; second determining means for determining whether or not the operating mode is changed from the first mode to the second mode; informing process means for performing a process of informing of a change in operating mode if it is determined that a change in operating mode is made; and first output means for outputting at least one of vibration, light, and sound according to a process by the informing process means. The controlled device includes: second communication means for receiving the control signal from the first communication means; and second process executing means for executing a process corresponding to the received control signal.

Preferably, the second communication means further transmits particular information to the mobile terminal device, the first communication means further receives the particular information, the first process executing means further processes the particular information received by the first communication means, and the second determining means determines that the operating mode is changed to the second mode if the particular information is received.

Preferably, the controlled device further includes third determining means for determining whether or not the control signal received by the second communication means is an instruction to transmit the particular information, and the second process executing means executes a process of transmitting the particular information from the second communication means to the mobile terminal device if it is determined that the control signal is an instruction to transmit the particular information.

Preferably, the informing process means further performs a process of transmitting a change signal indicating a change in object to be operated, from the first communication means to the controlled device if it is determined by the second determining means that a change in operating mode is made, the controlled device further includes: informing process means for performing a process of informing that the operating mode in the mobile terminal device is changed to the second mode if the change signal is received; and second output means for outputting predetermined information according to a process by the informing process means.

A mobile terminal device according to another aspect of the present invention is a mobile terminal device capable of communicating with a controlled device performing a process corresponding to a received control signal. The mobile terminal includes: input means for accepting an instruction; first determining means for determining specifics of an instruction based on a signal from the input means, according to a current operating mode of either a first mode controlling the controlled device or a second mode performing a process for the mobile terminal device; communication means for transmitting a control signal corresponding to determined specifics of an instruction, to the controlled device when in the first mode; process executing means for executing a process corresponding to determined specifics of an instruction when in the second mode; second determining means for determining whether or not the operating mode is changed from the first mode to the second mode; informing process means for performing a process of informing of a change in operating mode if it is determined that a change in operating mode is made; and output means for outputting at least one of vibration, light, and sound according to a process by the informing process means.

Preferably, the communication means further receives particular information from the controlled device, the process executing means further processes the particular information received by the communication means, and the second determining means determines that the operating mode is changed to the second mode if the particular information is received.

Preferably, the informing process means further performs a process of transmitting a change signal indicating a change in object to be operated, from the communication means to the controlled device if it is determined by the second determining means that a change in operating mode is made.

A controlled device according to still another aspect of the present invention is a controlled device capable of communicating with a mobile terminal device. The mobile terminal device determines whether or not an operating mode in the mobile terminal device is changed from a first mode controlling the controlled device to a second mode performing a process for the mobile terminal device, and transmits a change signal indicating a change in object to be operated, to the controlled device if it is determined that a change in operating mode is made. The controlled device includes: communication means for receiving a control signal and the change signal from the mobile terminal device; process executing means for executing a process corresponding to the control signal if the control signal is received; informing process means for performing a process of informing that the operating mode in the mobile terminal device is changed to the second mode if the change signal is received; and output means for outputting predetermined information according to a process by the informing process means.

Preferably, the output means includes display means for displaying the predetermined information.

A control method according to a further aspect of the present invention is a control method for controlling a mobile terminal device capable of communicating with a controlled device performing a process corresponding to a received control signal. The method includes the steps of: accepting an instruction signal; determining specifics of an instruction indicated by the instruction signal, according to a current operating mode of either a first mode controlling the controlled device or a second mode performing a process for the mobile terminal device; transmitting a control signal corresponding to determined specifics of an instruction, to the controlled device when in the first mode; executing a process corresponding to determined specifics of an instruction when in the second mode; determining whether or not the operating mode is changed from the first mode to the second mode; and informing of a change in operating mode by at least one of vibration, light, and sound if it is determined that a change in operating mode is made.

A control method according to a further aspect of the present invention is a control method for controlling a controlled device capable of communicating with a mobile terminal device. The mobile terminal device determines whether or not an operating mode in the mobile terminal device is changed from a first mode controlling the controlled device to a second mode performing a process for the mobile terminal device, and transmits a change signal indicating a change in object to be operated, to the controlled device if it is determined that a change in operating mode is made. The control method includes the steps of: receiving a control signal and the change signal from the mobile terminal device; executing a process corresponding to the control signal if the control signal is received; and informing that the operating mode in the mobile terminal device is changed to the second mode if the change signal is received.

A control program according to a further aspect of the present invention is a control program for controlling a mobile terminal device capable of communicating with a controlled device performing a process corresponding to a received control signal. The control program includes the steps of: accepting an instruction signal; determining specifics of an instruction indicated by the instruction signal, according to a current operating mode of either a first mode controlling the controlled device or a second mode performing a process for the mobile terminal device; transmitting a control signal corresponding to determined specifics of an instruction, to the controlled device when in the first mode; executing a process corresponding to determined specifics of an instruction when in the second mode; determining whether or not the operating mode is changed from the first mode to the second mode; and informing of a change in operating mode by at least one of vibration, light, and sound if it is determined that a change in operating mode is made.

A control program according to a further aspect of the present invention is a control program for controlling a controlled device capable of communicating with a mobile terminal device. The mobile terminal device determines whether or not an operating mode in the mobile terminal device is changed from a first mode controlling the controlled device to a second mode performing a process for the mobile terminal device, and transmits a change signal indicating a change in object to be operated, to the controlled device if it is determined that a change in operating mode is made. The control program includes the steps of: receiving a control signal and the change signal from the mobile terminal device; executing a process corresponding to the control signal if the control signal is received; and informing that the operating mode in the mobile terminal device is changed to the second mode if the change signal is received.

### Advantageous Effects of Invention

According to the present invention, a mobile terminal device determines, when in a first operating mode (mode controlling a controlled device), that the operating mode is changed to a second mode (mode performing a process for the terminal itself). Then, if it is determined that such a change is made, a user is informed of that effect by at least one of vibration, light, and sound.

Therefore, the user can readily notice a change in operating mode (state of a remote app), i.e. the fact that an object to be operated is changed from the controlled device to the terminal itself. As a result, reduction of misoperations during a remote control operation can be achieved.

### BRIEF DESCRIPTION OF DRAWINGS

FIG. 1 shows an exemplary configuration of a control system in an embodiment of the present invention.

FIG. 2 is a front view of an external appearance of a mobile terminal device in the embodiment of the present invention.

FIG. 3 is a block diagram showing an exemplary hardware configuration of the mobile terminal device in the embodiment of the present invention.

FIG. 4 is a block diagram showing an exemplary hardware configuration of a controlled device in the embodiment of the present invention.

FIG. 5 is a functional block diagram showing a functional configuration of the control system in the embodiment of the present invention.

FIG. 6 is a flow chart showing the operation of the control system in the embodiment of the present invention.

FIG. 7 shows a specific example of an operation executed by the control system of the embodiment of the present invention.

FIG. 8 is a flowchart showing an operation of a control system in a first modification of the embodiment of the present invention.

FIG. 9 shows a specific example of an operation executed by the control system of the first modification of the embodiment of the present invention.

FIG. 10 is a flowchart showing an operation of a control system in a second modification of the embodiment of the present invention.

FIG. 11 shows a specific example of an operation executed by the control system in the second modification of the embodiment of the present invention.

### DESCRIPTION OF EMBODIMENTS

An embodiment of the present invention will be described in detail with reference to the drawings. It is noted that in the drawings, the same or corresponding portions have the same reference signs allotted, and description thereof will not be repeated.

<As to Configuration>

(Configuration of Control System)

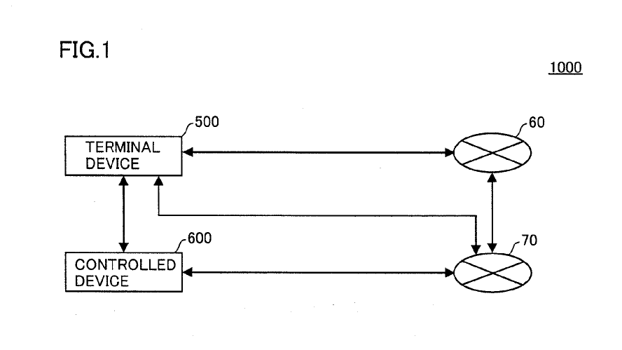

Referring to FIG. 1, the configuration of a control system 1000 in the present embodiment will be described.

Control system 1000 includes a mobile terminal device (hereinafter abbreviated to “mobile terminal”) 500 and a controlled device 600.

Mobile terminal 500 is a mobile telephone. It is noted that mobile terminal 500 is not limited to a mobile telephone and may be any device that is equipped with a communication function and portable (for example, a PDA (Personal Digital Assistance) or a PC (Personal Computer)).

Mobile terminal 500 can perform wireless data communication with a telephone network 60. Telephone network 60 is, for example, a telephone network for mobile telephones.

Controlled device 600 is a device controlled with a signal transmitted from mobile terminal 500. An example of controlled device 600 is a television receiver. It is noted that controlled device 600 is not limited to a television receiver and may be any device that is controlled with a signal transmitted from mobile terminal 500 (information outputting device). Controlled device 600 may be, for example, a video recording and reproducing device, a music reproducing device, a PC, or the like.

Mobile terminal 500 performs wireless or wired data communication with controlled device 600. Mobile terminal 500 has a function of performing wireless or wired data communication with a network 70. Network 70 is a wide-are network such as the Internet.

Controlled device 600 has a function of performing wireless or wired communication with network 70. Further, network 70 can perform wireless or wired data communication with telephone network 60. Thus, mobile terminal 500 can perform data communication via telephone network 60 with network 70.

(Mobile Terminal Device)

Next, mobile terminal 500 will be described in detail.

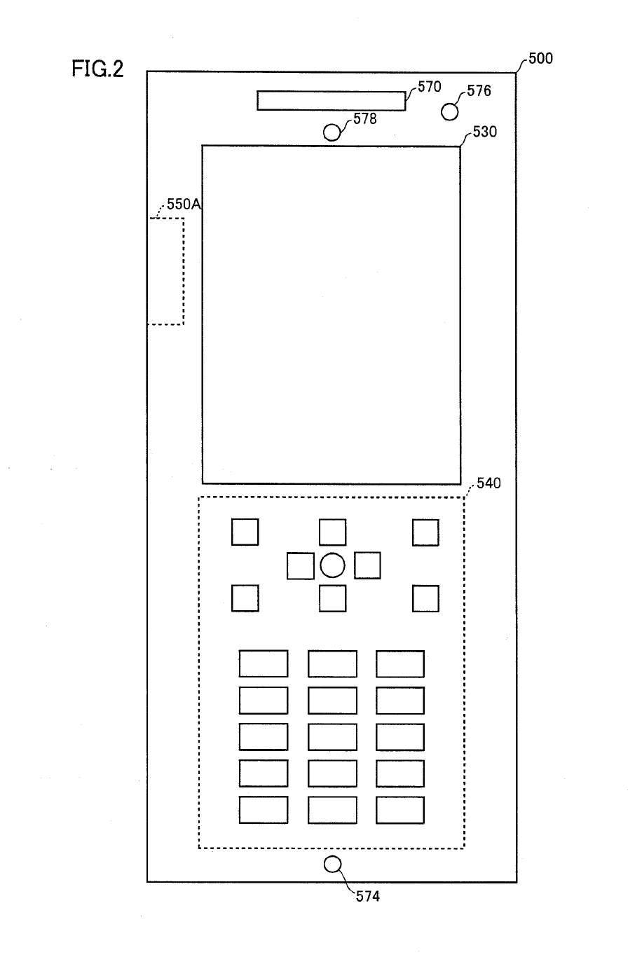

FIG. 2 is a front view of an external appearance of mobile terminal 500. Referring to FIG. 2, mobile terminal 500 includes a display unit 530, an audio output unit 570, an LED (Light Emitting Diode) 576, and an image capturing unit 578.

Display unit 530 has a function of displaying a character, an image, and the like. Display unit 530 is provided with a display surface for displaying a character, an image, and the like. Display unit 530 is a device using an LCD panel (Liquid Crystal Display Panel). It is noted that display unit 530 may be a device using a panel which employs a display system other than that mentioned above.

The display surface of display unit 530 has a resolution of 480 dots (width)×800 dots (height). It is noted that the resolution of the display surface of display unit 530 is not limited to 480 dots (width)×800 dots (height) and may be other resolutions.

Further, display unit 530 has a touch-panel function that enables a user to input information by touching the display surface directly. Display unit 530 transmits information of a position at which the user touches the display surface, to a control unit 510, which will be described later. Control unit 510 performs a predetermined process based on the received positional information.

Audio output unit 570 has a function of outputting audio of the telephone. Audio output unit 570 includes a speaker for outputting audio. From the speaker, audio output unit 570 outputs audio based on audio data received from control unit 510, which will be described later.

LED 576 provides information by light according to the process performed in mobile terminal 500. For instance, LED 576 flickers when there is an incoming call.

Image capturing unit 578 has a function of performing an image capturing process for capturing an image of an object to be imaged. Image capturing unit 578 includes an image capturing lens, a light receiving unit, and a color filter unit, all not shown. The light receiving unit has a function of converting received light into an electrical signal. The light receiving unit is formed of a plurality of light receiving elements. The light receiving element is, for example, an element using a CCD (Charge Coupled Device) image sensor, a CMOS (Complementary Metal Oxide Semiconductor) image sensor, or the like.

The color filter unit is formed of a plurality of color filters. The color filters are filters corresponding to R, G, and B, respectively. The plurality of color filters are provided corresponding to each of the plurality of light receiving elements.

In the image capturing process, the following processes are performed. First, image capturing unit 578 allows the light reflected by the object to be imaged and then entering the image capturing lens or the light from a light source (for example, lighting) to be received by the light receiving unit via the color filter unit. The light receiving unit converts the received light into an electrical signal. Image capturing unit 578 then converts the converted electrical signal into digital data (hereinafter also referred to as capturing image data).

Mobile terminal 500 further includes an operation unit 540. Operation unit 540 includes a plurality of buttons (for example, a cursor button, numeric keys, and the like).

Operation unit 540 transmits a button signal corresponding to a button subjected to a short depressing operation or a long depressing operation among the plurality of buttons included in operation unit 540, to control unit 510, which will be described later. That is, operation unit 540 is an interface for a user to operate mobile terminal 500. It is noted that in the present embodiment, depressing by a user for less than a predetermined period of time (for example, one second) shall be referred to as “short depressing operation” and depressing for the predetermined period of time or longer shall be referred to as “long depressing operation”.

Mobile terminal 500 further includes an audio input unit 574 and a recording medium insertion unit 550A. Audio input unit 574 has a function of inputting audio during a call. Audio input unit 574 includes a microphone for an audio input. Audio input unit 574 converts audio obtained by the microphone into audio data and transmits the audio data to control unit 510, which will be described later, in mobile terminal 500. Recording medium insertion unit 550A is a portion where a recording medium, which will be described later, is inserted into mobile terminal 500.

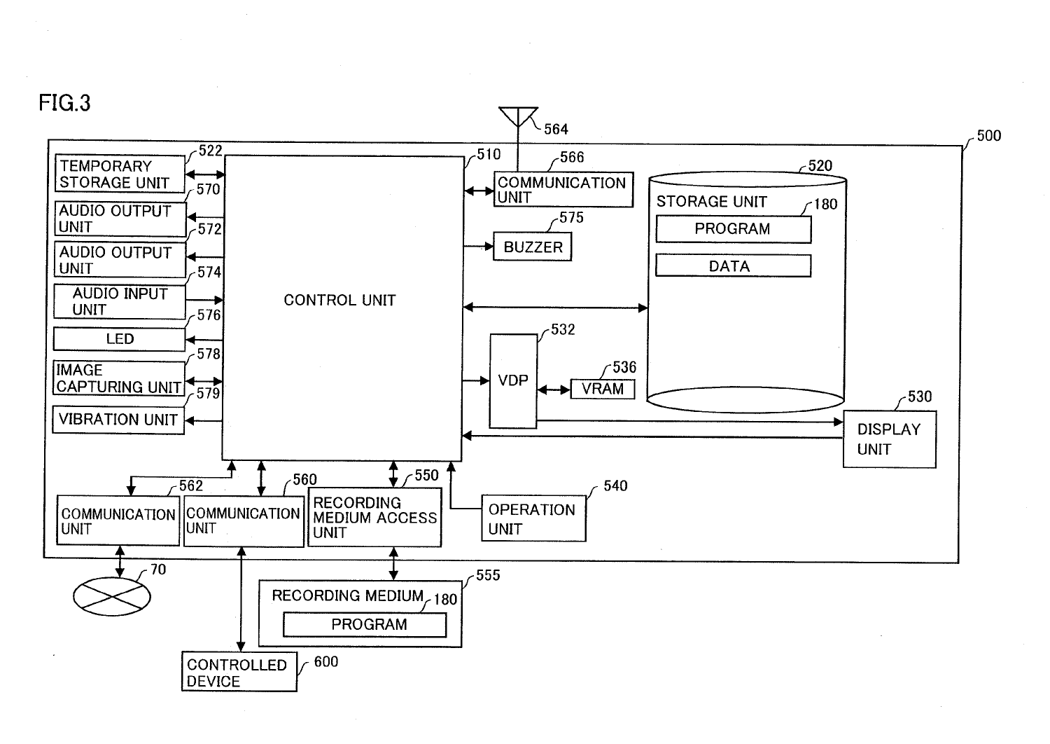

FIG. 3 is a block diagram showing an internal configuration of mobile terminal 500. It is noted that FIG. 3 also shows a recording medium 555 for the purpose of explanation. On recording medium 555, a program 180, which will be described later, is recorded. That is, program 180 is recorded on a medium or the like and distributed as a program product. Recording medium 555 is also distributed as a program product.

Referring to FIG. 3, mobile terminal 500 further includes control unit 510, a temporary storage unit 522, and a storage unit 520.

Storage unit 520 has a function of storing data in a nonvolatile manner. Storage unit 520 is accessed for data by control unit 510. Storage unit 520 is a medium capable of retaining data in a nonvolatile manner even without being supplied with power (for example, a flash memory). In storage unit 520, program 180, various other data, and the like are stored.

Control unit 510 has a function of performing various processes for the units in mobile terminal 500, a computing process, and the like, in accordance with program 180 stored in storage unit 520. Control unit 510 is a CPU (Central Processing Unit). It is noted that control unit 510 is not limited to a CPU and may be other circuits having a computation function.

Control unit 510 receives, from operation unit 540, a button signal corresponding to a button subjected to a long depressing operation or a short depressing operation among the above-described plurality of buttons included in operation unit 540. Control unit 510 performs a process according to the received button signal.

Temporary storage unit 522 is used as a work memory which is accessed for data by control unit 510 and temporarily stores data. Temporary storage unit 522 is a DRAM (Dynamic Random Access Memory). It is noted that temporary storage unit 522 is not limited to a DRAM and may be other circuits capable of storing data in a volatile manner.

Mobile terminal 500 further includes a VDP 532 (Video Display Processor) and a VRAM (Video Random Access Memory) 536.

VRAM 536 has a function of temporarily storing image data.

Control unit 510 provides a drawing instruction to VDP 532 in accordance with program 180 stored in storage unit 520. The drawing instruction is an instruction to generate an image and cause display unit 530 to display the image.

VDP 532 is connected to display unit 530. According to the drawing instruction from control unit 510, VDP 532 reads font data, graphic data, and the like from program 180, which will be described later, in storage unit 520 and generates an image utilizing VRAM 536. VDP 532 then reads image data stored in VRAM 536 and causes display unit 530 to display an image based on the image data.

Mobile terminal 500 further includes a recording medium access unit 550.

When recording medium 555 is inserted (mounted) into mobile terminal 500 from recording medium insertion unit 550A as described above, recording medium access unit 550 can perform data access to recording medium 555. This enables recording medium access unit 550 to read program 180 from recording medium 555 on which program 180 is recorded.

Program 180 stored in recording medium 555 is read by recording medium access unit 550 through an install process performed by control unit 510, and control unit 510 causes program 180 to be stored in storage unit 520. A program for the install process is contained in storage unit 520 in advance, and the install process is performed by control unit 510 based on the program for the install process.

It is noted that storage unit 520 may not have program 180 installed therein. In this case, control unit 510 reads program 180 stored in recording medium 555 via recording medium access unit 550 and performs a predetermined process based on program 180. On recording medium 555, further, content data and the like are recorded. The content data is, for example, music data, moving image data, and the like.

Recording medium 555 is an SD (Secure Digital®) memory card. It is noted that recording medium 555 is not limited to an SD® memory card and may be other media capable of recording data in a nonvolatile manner.

Mobile terminal 500 further includes a communication unit 560 and a communication unit 562.

Communication unit 560 transmits and receives data to and from control unit 510. Further, communication unit 560 has a function of transmitting and receiving data to and from controlled device 600 by wire or wirelessly.

Communication unit 560 has a function of a communication interface for performing serial transfer, based on the USB® (Universal Serial Bus) 2.0 standard. The standard for a communication interface for performing serial transfer is not limited to USB® 2.0 and may be other standards.

It is noted that communication unit 560 may have a function of communication interface for performing parallel transfer. The communication interface for performing parallel transfer is, for example, an interface in accordance with a Centronics-compliant standard. Communication unit 560 may have a function of communication interface based on IEEE1394 or the SCSI standard.

In addition, communication unit 560 further has a wireless data communication function. The wireless data communication function has a function of performing wireless data communication using Bluetooth®. It is noted that the wireless data communication is not limited to a system using Bluetooth® and may be other communication systems using, for example, infrared rays or the like. Communication unit 560 performs wireless data communication with controlled device 600 according to a control instruction from control unit 510.

Communication unit 562 transmits and receives data to and from control unit 510. Communication unit 562 has a function of performing data communication with network 70, utilizing a wired technique. The wired technique is, for example, a technique based on Ethernet®. In this case, communication unit 562 can perform data communication with a network 70 via a LAN cable, for example. It is noted that the wired technique is not limited to the technique based on Ethernet® and may be other wired techniques.

Further, communication unit 562 has a function of performing data communication with network 70, utilizing a wireless technique. The wireless technique is, for example, a technique based on IEEE802.11g. It is noted that the wireless technique is not limited to the technique based on IEEE802.11g and may be other wireless techniques. Thus, communication unit 562 can perform wireless data communication with network 70.

Mobile terminal 500 further includes an antenna 564 and a communication unit 566.

Antenna 564 is connected to communication unit 566. Communication unit 566 has a function of transmitting/receiving a radio communication signal utilizing antenna 564. Communication unit 566 receives, via antenna 564, a radio communication signal of a frequency designated by control unit 510. Radio communication signal is a signal including audio data, character data, image data, and the like.

Communication unit 566 utilizes antenna 564 to communicate with the closest base station, not shown, with the radio communication signal. The closest base station can communicate with telephone network 60. Therefore, communication unit 566 utilizes antenna 564 to communicate with telephone network 60 via the closest base station, with the radio communication signal. Receiving a radio communication signal, communication unit 566 demodulates the radio communication signal and transmits data based on the demodulated radio communication signal, to control unit 510. Further, when a radio communication signal is to be transmitted, communication unit 566 receives data (for example, audio data) from control unit 510 and converts the data to a radio communication signal based on a predetermined protocol. Communication unit 566 then utilizes antenna 564 to transmit the converted radio communication signal to telephone network 60 via the closest base station, not shown.

Communication unit 566 can also obtain information indicating the position of the base station (hereinafter also referred to as base station positional information), through communication with the closest base station. Communication unit 566 transmits the obtained base station positional information to control unit 510 according to a control instruction from control unit 510. Based on the received base station positional information, control unit 510 can roughly grasp the position of mobile terminal 500.

Further, communication unit 566 has a GPS (Global Positioning System) function. A GPS function is a function of obtaining information (hereinafter also referred to as GPS positional information) on the position (position based on longitude, latitude, altitude, and the like) of mobile terminal 500, by communicating with an artificial satellite. Communication unit 566 obtains the GPS positional information according to a control instruction from control unit 510 and transmits the information to control unit 510.

Mobile terminal 500 can also perform a process for downloading a program from network 70 via telephone network 60 and store the program in storage unit 520, through processes by control unit 510 and communication unit 562. In this case, the downloaded program is program 180.

Control unit 510 performs a predetermined process in accordance with the program (program 180) downloaded from network 70. A program for the downloading is stored in storage unit 520 in advance, and the download process is performed by control unit 510 based on the program for the downloading.

Mobile terminal 500 further includes an audio output unit 572. Audio output unit 572 is provided on the outside of mobile terminal 500. Audio output unit 572 has a function of outputting audio corresponding to a process performed in control unit 510. Audio output unit 572 includes a speaker for outputting audio. From the speaker, audio output unit 572 outputs audio based on audio data received from control unit 510.

Control unit 510 performs data communication with audio output unit 570 and audio input unit 574 as described above.

When control unit 510 transmits audio data to audio output unit 570, audio output unit 570 outputs audio based on the audio data received from control unit 510.

When a user provides audio to the microphone included in audio input unit 574, audio input unit 574 converts the audio obtained by the microphone into audio data and transmits the audio data to control unit 510.

Control unit 510 performs data communication with a buzzer 575. Buzzer 575 generates a notification sound based on a control instruction from control unit 510. It is noted that the function of buzzer 575 may be served by audio output unit 572.

Control unit 510 performs data communication with each of LED 576 and image capturing unit 578 as described above. LED 576 emits light based on a control instruction from control unit 510.

Image capturing unit 578 performs the above-described image capturing process based on a control instruction from control unit 510 and transmits the picked-up image data to control unit 510. Receiving the picked-up image data, control unit 510 causes the picked-up image data to be store in any of temporary storage unit 522, storage unit 520, and recording medium 555.

Mobile terminal 500 further includes a vibration unit 579. Vibration unit 579 has a function of vibrating mobile terminal 500 by vibration of vibration unit 579 itself, based on a control instruction from control unit 510. Vibration unit 579 vibrates mobile terminal 500 based on a control instruction from control unit 510 at the time of, for example, receiving an incoming call and an electronic mail.

(Controlled Device)

Next, controlled device 600 will be described in detail.

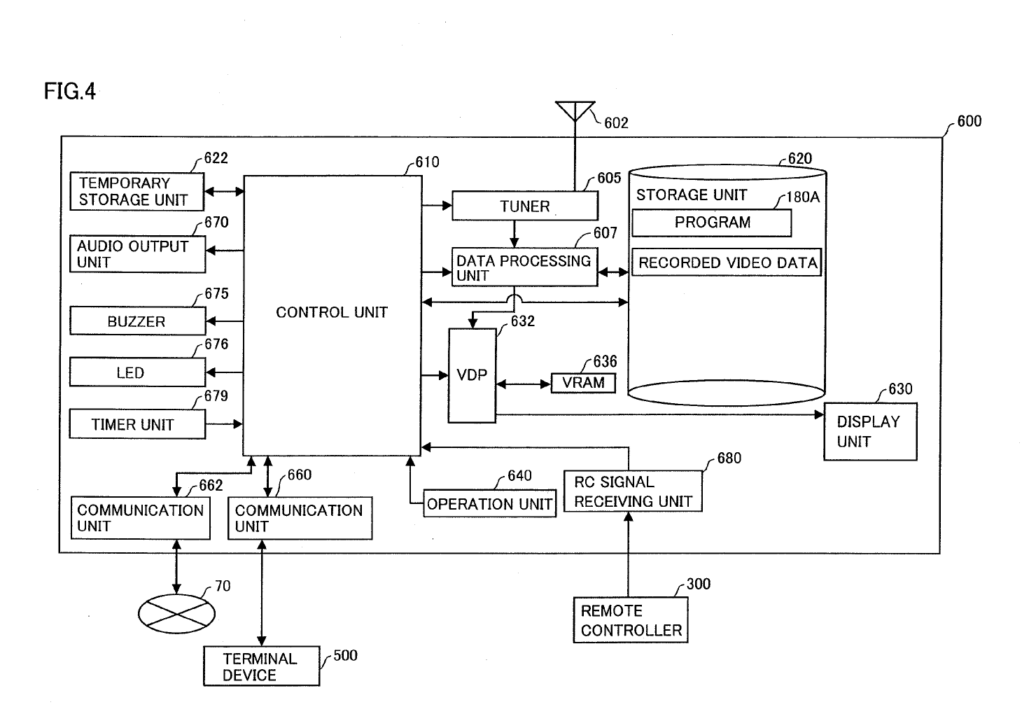

FIG. 4 is a block diagram showing an internal configuration of controlled device 600. Referring to FIG. 4, controlled device 600 includes a display unit 630 and an audio output unit 670. Display unit 630 has a function of displaying a character, an image, and the like. Display unit 630 is a device using an LCD panel (Liquid Crystal Display Panel). It is noted that display unit 630 may be a device using a panel which employs a display system other than that mentioned above.

The size of an image that can be displayed on display unit 630 is larger than the size of an image that can be displayed on display unit 530. Further, the resolution of display unit 630 is higher than the resolution of display unit 530. For example, display unit 630 has a resolution of 1920 dots (width)×1080 dots (height). It is noted that the resolution of display unit 630 is not limited to 1920 dots (width)×1080 dots (height) and may be other resolutions.

Audio output unit 670 is provided on the outside of controlled device 600. Audio output unit 670 has a function of outputting audio corresponding to a process performed in a control unit 610, which will be described later. Audio output unit 670 includes a speaker for outputting audio. From the speaker, audio output unit 670 outputs audio based on audio data received from control unit 610, which will be described later.

Controlled device 600 further includes control unit 610, a temporary storage unit 622, and a storage unit 620.

Storage unit 620 has a function of storing data in a nonvolatile manner. Storage unit 620 is accessed for data by control unit 610. Storage unit 620 is a hard disk capable of storing a large capacity of data. It is noted that storage unit 620 is not limited to a hard disk and may be any medium that can retain data in a nonvolatile manner even without being supplied with power (for example, a flash memory). Stored in storage unit 620 are a program 180A, recorded video data, which will be described later, various other data, and the like.

Control unit 610 has a function of performing various processes for the units in controlled device 600, a computing process, and the like, in accordance with program 180A stored in storage unit 620. Control unit 610 is the same as control unit 510 as described above, and therefore, detailed description will not be repeated.

Temporary storage unit 622 is used as a work memory which is accessed for data by control unit 610 and temporarily stores data. Temporary storage unit 622 is the same as temporary storage unit 522 as described above, and therefore, detailed description will not be repeated.

Controlled device 600 further includes an antenna 602, a tuner 605, and a data processing unit 607.

Antenna 602 is connected to tuner 605. Tuner 605 receives, via antenna 602, a broadcast signal of a frequency designated by control unit 610. Tuner 605 has a function of receiving a digital-broadcast-based broadcast signal and an analogue-broadcast-based broadcast signal. Tuner 605 transmits the received broadcast signal to data processing unit 607.

Receiving, from control unit 610, a display instruction to cause display unit 630 to display an image, data processing unit 607 obtains image data from the received broadcast signal and transmits the image data to a VDP 632, which will be described later. Receiving the image data, VDP 632 causes display unit 630 to display an image (moving image or still image) based on the image data. Hereinafter, an image which is based on a broadcast signal received by tuner 605 and displayed on display unit 630 will also be referred to as a TV image.

If the broadcast signal received by data processing unit 607 is an analogue-broadcast-based signal and if a video recording instruction to perform a video recording process is received from control unit 610, then data processing unit 607 compresses image data and audio data obtained from the broadcast signal and causes storage unit 620 to store them as recorded video data. If the broadcast signal received by data processing unit 607 is a digital-broadcast-based signal and if a video recording instruction to perform a video recording process is received from control unit 610, then data processing unit 607 causes storage unit 620 to record image data and audio data obtained from the broadcast signal, as recorded video data.

The recorded video data stored in storage unit 620 is data compressed in MPEG2 format. It is noted that recorded video data is not limited to data compressed in MPEG2 format and may be data compressed in other formats. Herein, other formats are, for example, H.264 and the like. Hereinafter, the recorded video data stored in storage unit 620 will also be referred to as contents.

Controlled device 600 further includes VDP 632 and a VRAM 636.

VRAM 636 has a function of temporarily storing image data.

Control unit 610 provides a drawing instruction to VDP 632 in accordance with program 180A stored in storage unit 620. The drawing instruction is an instruction to generate an image and cause display unit 630 to display the image.

VDP 632 is connected to display unit 630. According to the drawing instruction from control unit 610, VDP 632 reads font data, graphic data, and the like from program 180A, which will be described later, in storage unit 620 and generates an image utilizing VRAM 636. VDP 632 then reads the image data stored in VRAM 636 and causes display unit 630 to display an image based on the image data.

Controlled device 600 further includes an operation unit 640.

Operation unit 640 includes a plurality of buttons, not shown. The plurality of buttons are provided on the outside of controlled device 600. When any of the plurality of buttons is subjected to a depressing operation by a user, operation unit 640 transmits a button signal corresponding to the button subjected to the depressing operation, to control unit 610. Control unit 610 performs a predetermined process based on the received button signal.

Controlled device 600 further includes a communication unit 660 and a communication unit 662.

Communication unit 660 transmits and receives data to and from control unit 610. Further, communication unit 660 has a function of transmitting and receiving data to and from mobile terminal 500 by wire or wirelessly. It is noted that communication unit 660 has the same constitution and functions as those of communication unit 560 as described above, and therefore, detailed description will not be repeated.

Communication unit 662 transmits and receives data to and from control unit 610. Communication unit 662 has a function of performing data communication with network 70, utilizing a wired technique. The wired technique is, for example, a technique based on Ethernet®. In this case, communication unit 662 can perform data communication with network 70 via a LAN cable, for example. It is noted that the wired technique is not limited to the technique based on Ethernet® and may be other wired techniques.

Further, communication unit 662 has a function of performing data communication with network 70, utilizing a wireless technique. The wireless technique is, for example, a technique based on IEEE802.11g. It is noted that the wireless technique is not limited to the technique based on IEEE802.11g and may be other wireless techniques. Thus, communication unit 662 can perform wireless data communication with network 70.

Therefore, controlled device 600 in the present embodiment can also perform a process for downloading a program from network 70 via communication unit 662 and store the program in storage unit 620. In this case, the downloaded program is program 180A.

Control unit 610 performs a predetermined process in accordance with the program (program 180A) downloaded from network 70. A program for the downloading is stored in storage unit 620 in advance, and the download process is performed by control unit 610 based on the program for downloading.

Controlled device 600 further includes an RC signal receiving unit 680. RC signal receiving unit 680 has a function of receiving a remote control signal (hereinafter also referred to as RC signal) for controlling controlled device 600, outputted from a remote controller 300. RC signal receiving unit 680 transmits a received RC signal to control unit 610. Control unit 610 performs a corresponding process according to the received RC signal.

It is noted that hereinafter, a remote control signal for controlling controlled device 600, transmitted from communication unit 560 of mobile terminal 500 will also be referred to as RC signal. In this case, communication unit 660 receives an RC signal transmitted from mobile terminal 500 and transmits the received RC signal to control unit 610. Control unit 610 performs a corresponding process according to the received RC signal.

Control unit 610 performs data communication with audio output unit 670 as described above. When control unit 610 transmits audio data to audio output unit 670, audio output unit 670 outputs, from the speaker, audio based on the audio data received from control unit 610.

Control unit 610 performs data communication with a buzzer 675. Buzzer 675 generates a notification sound based on a control instruction from control unit 610. It is noted that the function of buzzer 675 may be served by audio output unit 670.

Control unit 610 performs data communication with an LED 676. LED 676 emits light based on a control instruction from control unit 610.

Controlled device 600 further includes a timer unit 679 for performing a timer operation.

(Functional Configuration)

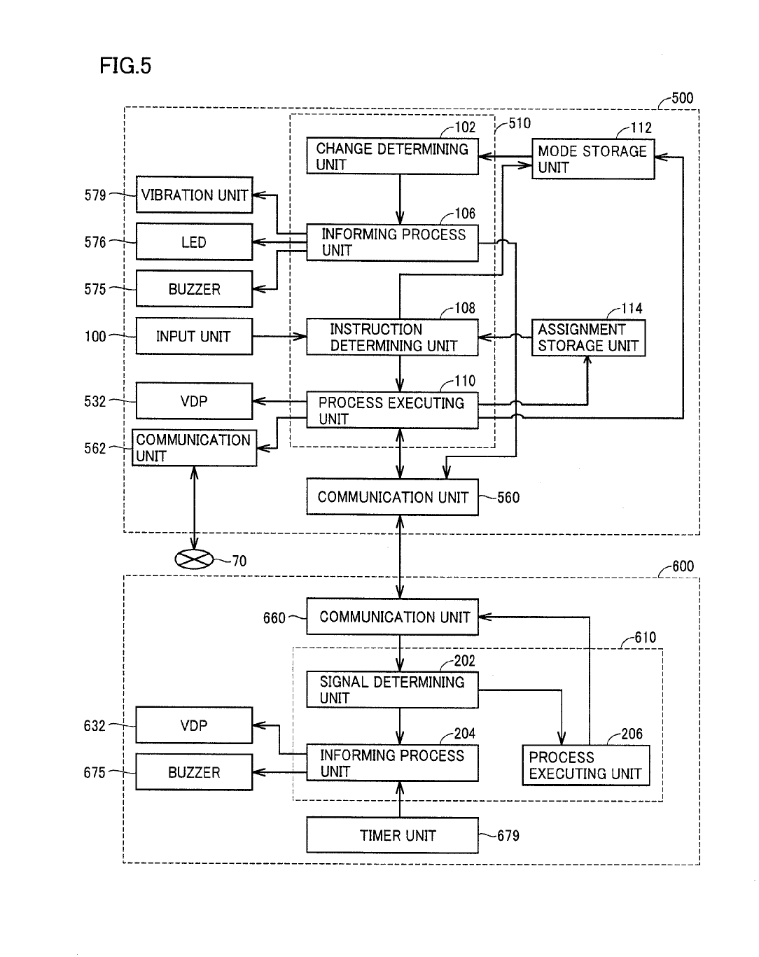

FIG. 5 is a functional block diagram showing a functional configuration of the control system in the embodiment of the present invention.

First, functions of mobile terminal 500 will be described.

Mobile terminal 500 includes, as its functions, an input unit 100, a change determining unit 102, an informing process unit 106, an instruction determining unit 108, a process executing unit 110, a mode storage unit 112, and an assignment storage unit 114. It is noted that program 180 as described above shall include a remote app (remote control application program). Control unit 510 may realize, by running the remote app, the functions of change determining unit 102, informing process unit 106, instruction determining unit 108, and process executing unit 110 among these functional blocks, or hardware may realize at least one of these functions.

Input unit 100 accepts instructions from a user. Input unit 100 includes, for example, operation unit 540 and (at least part of) display unit 530 that functions as a touch panel, which are shown in FIG. 3.

Mode storage unit 112 stores the current operating mode. That is, mode storage unit 112 stores a mode identification flag which serves as identification information indicating either a controlled-device operating mode or a terminal-itself operating mode. For instance, the mode identification flag is set to “0” in the controlled-device operating mode and set to “1” in the terminal-itself operating mode. It is noted that “controlled-device operating mode” represents a mode controlling (operating) a controlled device, while “terminal-itself operating mode” represents a mode performing a process for mobile terminal 500.

Assignment storage unit 114 stores information for specifying an instruction to be assigned to each button (including a soft button) for functioning as input unit 100. Specifically, for example, a plurality of pieces of data specifying specifics of an instruction are stored associated with respective data on the positional ranges of the buttons.

Mode storage unit 112 and assignment storage unit 114 correspond to, for example, a predetermined regions in temporary storage unit 522 shown in FIG. 3.

Change determining unit 102 periodically monitors mode storage unit 112 and determines whether or not the operating mode is changed while a remote app is running. If it is determined that the operating mode is changed to the terminal-itself operating mode, change determining unit 102 transmits a notification signal to informing process unit 106.

It is noted that a method for determining whether or not the operating mode is changed is not limited to this method, and the timing of when an operation is made by the user or the timing of when a signal is received from controlled device 600 may serve as well.

Informing process unit 106 performs a process for informing the user that the operating mode is changed from the controlled-device operating mode to the terminal-itself operating mode. Specifically, for example, informing process unit 106 transmits a control signal to vibration unit 579 and causes mobile terminal 500 to vibrate. Further, informing process unit 106 transmits a control signal to LED 576 and causes LED 576 to emit light. Furthermore, informing process unit 106 transmits a control signal to buzzer 575 and causes it to generate a notification sound.

Informing process unit 106 may further perform a process of transmitting a change signal which indicates a change in object to be controlled (information on a change in object to be operated), to controlled device 600.

Instruction determining unit 108 determines the specifics of the instruction from the user, based on a signal from input unit 100. For determination of the specifics of the instruction, the information stored in assignment storage unit 114 is used. Instruction determining unit 108 outputs the determined specifics of the instruction, to process executing unit 110. Further, according to the determined specifics of the instruction, instruction determining unit 108 can also perform a process of rewriting the mode identification flag in mode storage unit 112.

Process executing unit 110 executes various processes according to the specifics of the instruction from instruction determining unit 108. Process executing unit 110 performs a process of rewriting the mode identification flag in mode storage unit 112 in a predetermined case (for example, if particular information is transmitted from controlled device 600). Further, process executing unit 110 also performs a process of rewriting the information in assignment storage unit 114 according to a display screen change and the like. It is noted that a change in instructions assigned to the buttons can be realized by a known technique, and therefore, detailed description will not be given.

Next, functions of controlled device 600 will be described.

Controlled device 600 includes, as its functions, a signal determining unit 202, an informing process unit 204, and a process executing unit 206. It is noted that program 180A as described above shall include a control program for realizing a process according to a signal from a remote controlling equipment. Control unit 610 may realize these functions by running the control program, or hardware may realize at least one of these functions.

Signal determining unit 202 determines the process requested by an operation signal from mobile terminal 500, obtained from communication unit 660. Signal determining unit 202 then outputs a result of the determination to process executing unit 206. Further, if it is determined that the information on a change in object to be operated is received from mobile terminal 500, signal determining unit 202 notifies informing process unit 204.

Informing process unit 204 transmits a control signal to VDP 632 and displays predetermined information in a predetermined display region of display unit 630, thereby notifying the user that the operating mode is changed to mobile terminal 500. Specifically, for example, a predetermined icon (hereinafter also referred to as “notification icon”) is displayed on a screen of display unit 630. Further, informing process unit 204 transmits a control signal to buzzer 675 and causes it to generate a notification sound. Determining that a predetermined period of time has passed based on a timer signal from timer unit 679, informing process unit 204 terminates the informing process.

Process executing unit 206 executes various processes based on an instruction from signal determining unit 202. Process executing unit 206 may also autonomously transmit, to mobile terminal 500, information relating to information being outputted.

<As to Operation>

Next, the operation of the control system in the present embodiment will be described.

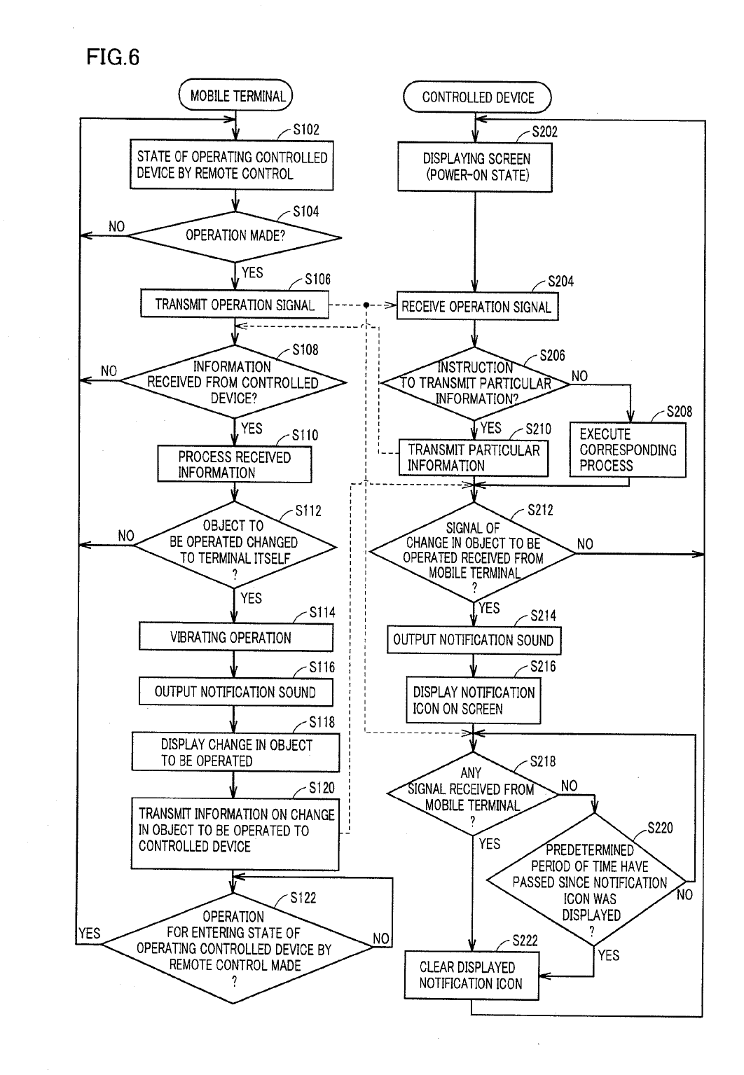

FIG. 6 is a flow chart showing the operation of the control system in the embodiment of the present invention. The processes shown in the flow chart of FIG. 6 are stored in storage unit 520 as a remote app, and this application program is exercised through being read and executed by control unit 510.

Referring to FIG. 6, first, the state of the remote app of mobile terminal 500 is a state of operating controlled device 600 by remote control, that is, the controlled-device operating mode (step S102). Therefore, the mode identification flag in mode storage unit 112 is 0. Controlled device 600 is displaying a screen (in a power-on state) (step S202).

In that state, instruction determining unit 108 of mobile terminal 500 determines whether or not an operation is made by a user (step S104). That is, it is determined whether or not an instruction signal from the user is inputted from input unit 100. If no operation is made (NO in step S104), the process returns to step S102.

If it is determined that an operation is made (YES in step S104), instruction determining unit 108 determines the specifics of the present instruction based on the information stored in assignment storage unit 114. In this stage, the operating mode is the controlled-device operating mode. Therefore, when the specifics of the instruction are determined, process executing unit 110 transmits an operation signal (control signal) according to the specifics of the instruction via communication unit 560 to controlled device 600 (step S106).

Communication unit 660 of controlled device 600 receives the operation signal from mobile terminal 500 (step S204). Signal determining unit 202 determines whether or not the instruction indicated by the operation signal is an instruction to transmit particular information (step S206). If it is determined that the instruction is an instruction to transmit particular information (YES in step S206), the process proceeds to step S210. On the other hand, if it is determined that the instruction is not an instruction to transmit particular information (NO in step S206), the process proceeds to step S208.

“Particular information” is information the receipt of which by mobile terminal 500 necessitates a process for the terminal itself, i.e. information the receipt of which by mobile terminal 500 causes or could cause a shift to the terminal-itself operating mode. Specific examples of particular information will be described later.

In step S208, process executing unit 206 executes a corresponding process.

In step S210, process executing unit 206 transmits the requested particular information to mobile terminal 500. Specifically, process executing unit 206 transmits particular information via communication unit 660 to mobile terminal 500.

When communication unit 560 of mobile terminal 500 receives the information from controlled device 600 (YES in step S108), process executing unit 110 processes the received information (step S110). Specifically, process executing unit 110 performs a process of displaying the received information on display unit 530. This changes the position and/or definition of buttons on display unit 530 functioning as a touch panel. Therefore, process executing unit 110 simultaneously rewrites information stored in assignment storage unit 114.

It is noted that process executing unit 110 shall rewrites information in assignment storage unit 114 as appropriate at every screen change even during the same mode.

Process executing unit 110 further rewrites information in mode storage unit 112 from the controlled-device operating mode to the terminal-itself operating mode. That is, the mode identification flag is set to 1.

If no information is received from controlled device 600 (NO in step S108), the process returns to step S102.

Next, change determining unit 102 of mobile terminal 500 determines whether or not the object to be operated is changed to the terminal itself (step S112). Specifically, it is determined whether or not the mode identification flag stored in mode storage unit 112 is changed from 0 to 1, i.e. whether or not a change from the controlled-device operating mode to the terminal-itself operating mode is made. If no mode change is made (NO in step S112), the process returns to step S102.

On the other hand, if it is determined that a mode change is made (YES in step S112), informing process unit 106 transmits a control signal to vibration unit 579 to perform a vibrating operation (step S114). Further, informing process unit 106 transmits a control signal to buzzer 575 to output a notification sound (step S116). Still further, informing process unit 106 may provide a notification of a change in object to be operated, on the screen of display unit 530 for a predetermined period of time (step S118). Further yet, informing process unit 106 may cause LED 576 to emit light. In addition, informing process unit 106 transmits the information on a change in object to be operated, to controlled device 600 (step S120).

Signal determining unit 202 of controlled device 600 determines, after the process in step S208 or S210, whether or not a signal of a change in object to be operated is received from the mobile terminal 500 (step S212). If the signal is not received (NO in step S212), the process returns to step S202. On the other hand, if it is determined that such a signal is received (YES in step S212), informing process unit 204 transmits a control signal to buzzer 675 to output a notification sound (step S214). Further, informing process unit 204 transmits a control signal to VDP 632 to display a notification icon on the screen (step S216).

Next, signal determining unit 202 of controlled device 600 determines whether or not any signal is received from mobile terminal 500 (step S218). If it is determined that some signal is received (YES in step S218), the process proceeds to step S222. If it is determined that no signal is received from mobile terminal 500 (NO in step S218), the process proceeds to step S220.

In step S220, informing process unit 204 determines whether or not a predetermined period of time has passed since the notification icon was displayed. If the predetermined period of time has not passed, the process returns to step S218. On the other hand, if it is determined that the predetermined period of time has passed (YES in step S220), the process proceeds to step S222.

In step S222, informing process unit 204 clears the displayed notification icon. When the process of step S222 ends, the process returns to step S202.

Mobile terminal 500 determines, after the process of step S120 as described above, whether or not an operation for entering a state of operating controlled device 600 by remote control (hereinafter also referred to as “return operation”) is made, i.e. whether or not the operating mode is returned to the controlled-device operating mode (step S122). Specifically, the above-described determination is made in the following procedure. First, instruction determining unit 108 determines whether or not the return operation is made based on the information in assignment storage unit 114 and a signal from input unit 100 (for example, positional data). Determining the return operation, instruction determining unit 108 rewrites mode information in mode storage unit 112 from the terminal-itself operating mode to the controlled-device operating mode. That is, the mode identification flag is set to 0. Change determining unit 102 periodically monitors the information in mode storage unit 112 and thus detects that the operating mode is returned to the controlled-device operating mode.

It is noted that when an operation other than the return operation is being performed, instruction determining unit 108 shall notify process executing unit 110 of the determined specifics of the instruction, and a process according to the specifics of the instruction shall be being executed by process executing unit 110. Further, process executing unit 110 shall also be rewriting the information in assignment storage unit 112 as appropriate in accordance with a screen change.

When it is detected that a return operation is made (YES in step S122), the process returns to the first step S102.

The processes above are repeated until the remote app is closed down.

It is noted that FIG. 6 shows one example of the order of the processes, which are not limited to the order as described above. For instance, the processes from steps S114 to S120 may be executed in parallel and can be in any order when executed in series.

Further, although it is assumed in the present embodiment that mobile terminal 500 notifies of a change in object to be operated, by vibration, sound, and light, it is only necessary to provide information either by vibration or by sound.

Although the description has been given herein with an example of a temporary change in operating mode during execution of the remote app, information on the timing of close-down or interruption of the remote app may also be provided, as a change in the operating mode.

### AS TO SPECIFIC EXAMPLE

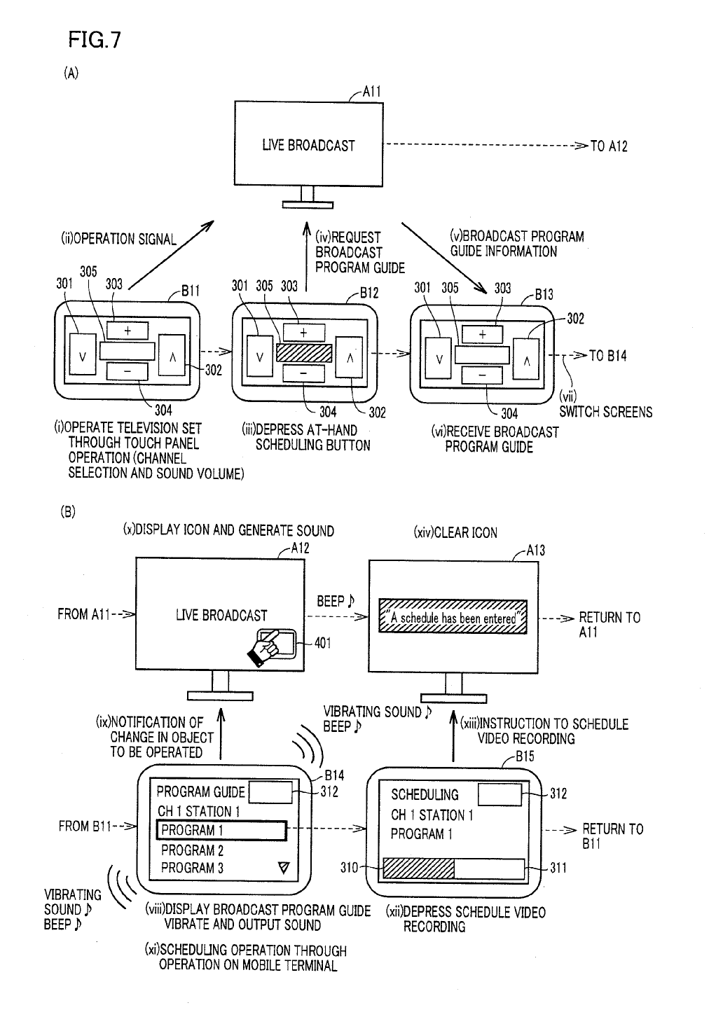

FIG. 7 shows a specific example of an operation executed by the control system of the embodiment of the present invention.

In this example, controlled device 600 is envisioned to be a television set. The scene envisioned is where a user using mobile terminal 500 as a remote controller wishes to check a broadcast program guide to schedule a video recording while viewing a live television broadcast without cluttering the screen (without displaying information other than the live broadcast).

FIG. 7(A) shows examples of screens of mobile terminal 500 and controlled device 600 in the controlled-device operating mode. FIG. 7(B) shows examples of screens of mobile terminal 500 and controlled device 600 in the terminal-itself operating mode.

Referring to FIG. 7(A), mobile terminal 500 is in the controlled-device operating mode (step S102). Controlled device 600 implemented by a television set is displaying a live broadcast (step S202). In such a state (i), displayed on display unit 530 of mobile terminal 500 is a screen like a screen B11. When in such a state, the user can remotely operate the television set through a touch panel operation.

Displayed on screen B11 are buttons 301, 302 used to select a channel, buttons 303, 304 for controlling sound volume, and an at-hand-scheduling button 305 for performing scheduling at hand. At-hand-scheduling button 305 is a button for accepting an instruction to output a signal requesting the television set to transmit a broadcast program guide so that the broadcast program guide can be displayed on mobile terminal 500.

It is assumed that the user operates channel selection buttons 301, 302 or sound volume control buttons 303, 304 (step S104). Then, as a state (ii), mobile terminal 500 transmits an operation signal to controlled device 600 (step S106). Controlled device 600 executes a process according to the operation signal (step S208).

Subsequently, as a state (iii), the user depresses at-hand-scheduling button 305 (step S104). Then, as a state (iv), mobile terminal 500 makes a request to controlled device 600 for a broadcast program guide as particular information (step S106).

Accepting a control signal requesting to transmit a broadcast program guide (step S206), controlled device 600 generates broadcast program guide information by a known method. Then, in a state (v), controlled device 600 transmits the generated broadcast program guide information to mobile terminal 500 (step S210).

In a state (vi), mobile terminal 500 receives a broadcast program guide (step S108). Then, as a state (vii), mobile terminal 500 switches an existing screen B13 to a screen B14 to be displayed next (step S110).

This changes the operating mode in mobile terminal 500 to the terminal-itself operating mode.

During states (i) to (vi), it is only the live broadcast that is being displayed on controlled device 600.

Referring to FIG. 7(B), being temporary shifted to the terminal-itself operating mode, mobile terminal 500 displays the received broadcast program guide (screen B14) while vibrating and outputting a notification sound, as a state (viii) (steps S110, S114, S116). This urges the user to look at the screen at the user's hand.

Displayed on screen B14 are information for identifying each broadcast program and a button 312 for returning display back to original screen B11.

Temporary being shifted to the terminal-itself operating mode, mobile terminal 500 further (simultaneously) notifies controlled device 600 of a change in object to be operated (transmits a change signal), as shown in a state (ix) (step S120).

Then, as a state (x), controlled device 600 displays, on display unit 630, an icon (symbol image) 401 as shown in a screen A12 and generates a notification sound (steps S214, S216). This can further ensure that the user is urged to look at the vicinity of the user's hand. It is noted that information displayed on display unit 630 of controlled device 600 is not limited to something like icon 401. For instance, a predetermined message may be displayed.

Subsequently, as a state (xi), it is assumed that the user operates the touch panel of mobile terminal 500 to perform a scheduling operation for a certain broadcast program. Then, display is shifted to a screen B15. Displayed on screen B15 are information for identifying the targeted broadcast program, a button 310 for scheduling a video recording of the targeted broadcast program, a button 311 for scheduling a viewing of the targeted broadcast program, and a back button 312.

In a state (xii), it is assumed that between buttons 310 and 311 displayed on screen B15, button 310 for scheduling a video recording is depressed (step S122). Then, mobile terminal 500 transmits an operation signal instructing controlled device 600 to schedule a video recording (state (xiii)).

Controlled device 600 receives the operation signal from mobile terminal 500 (step S218). Then, in a state (xiv), controlled device 600 clears icon 401 (step S222). Further, a message of “A schedule has been entered” may be displayed, as shown in a screen A13.

When scheduling of a video recording is completed in this way, the operating mode is returned to the controlled-device operating mode again. That is, on display unit 630 of controlled device 600, for example, a live broadcast is displayed again as screen A11 of FIG. 7(A). On display unit 530 of mobile terminal 500, for example, the buttons for remotely operating controlled device 600 are displayed again, as screen B11 of FIG. 7(A).

As described above, according to the present embodiment, if a shift to the terminal-itself operating mode is made during the controlled-device operating mode, a notification of a change in object to be operated is provided by vibration and/or sound. Therefore, the user can readily notice the change in object to be operated even when the user is watching the screen of controlled device 600, which is an object of a remote control operation.

Further, since the user can be urged to look at (the operation buttons) at the user's hand, by vibration and/or sound, the user's burden of having to constantly check the display screen can be reduced. Further, this results in that the user can smoothly continue an operation.

Further, a notification provided by vibration and/or sound eliminates unwittingly operating the terminal itself. As a result, misoperations by the user can be reduced. It is noted that in some circumstances, it is more preferable that no notification be provided. It is therefore preferable that mobile terminal 500 be configured such that various notifications can be collectively set as to whether or not to be provided, or various notifications can be individually set as to whether or not to be provided.

It is noted that although the particular information is implemented by a broadcast program guide in the present specific example, the particular information is not limited to contents information like a broadcast program guide. The particular information may be any information indicating a need to change the operating mode to the terminal-itself operating mode, such as a command to cause display unit 530 of mobile terminal 500 to display a broadcast program already transmitted to mobile terminal 500, for example.

<First Modification>

In the embodiment above, a control signal (operation signal) from the mobile terminal triggers transmission of the particular information from the controlled device. The particular information, however, may be one that is autonomously transmitted by the controlled device independently of a control signal from the mobile terminal. Such a form will be described as a first modification of the embodiment of the present invention.

It is noted that the configuration and basic operation of this control system are the same as those in the embodiment above. Therefore, descriptions will be given hereinafter only on differences from the embodiment above.

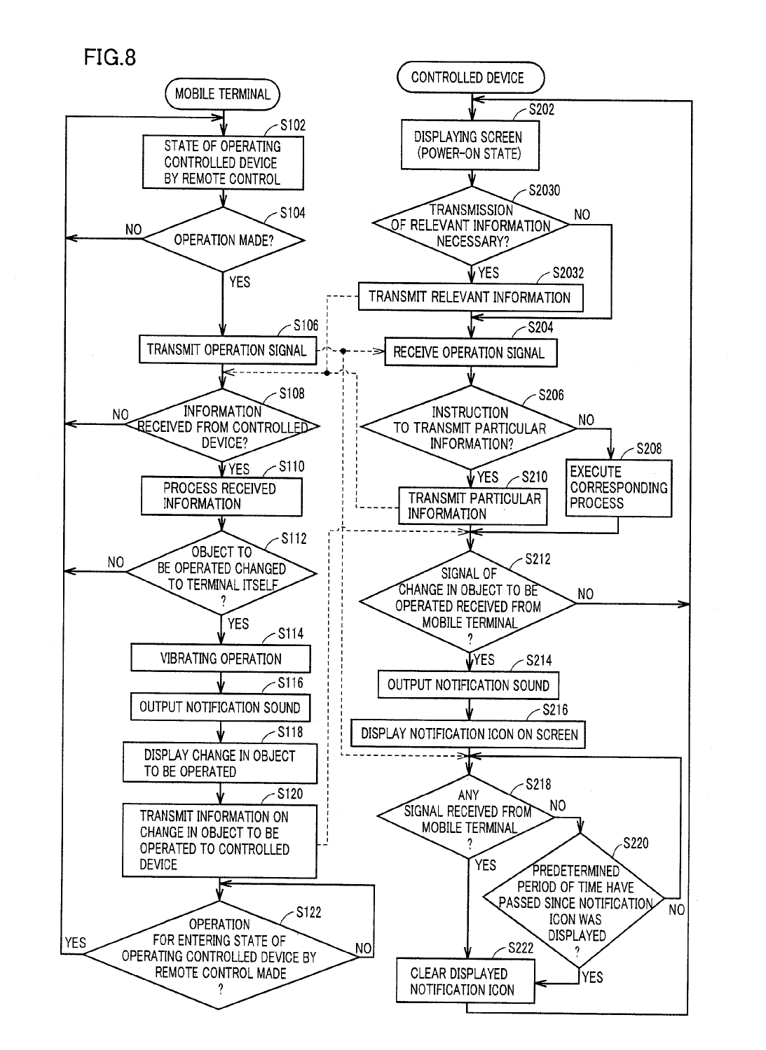

FIG. 8 is a flowchart showing the operation of the control system in the first modification of the embodiment of the present invention.

Referring to FIG. 8, as compared to the processes in the embodiment above, processes of steps S2030 and S2032 are interposed between steps S202 and S204 of controlled device 600.

In step S2030, process executing unit 206 of controlled device 600 determines whether or not it is necessary to transmit, as particular information, information relevant to contents being displayed. If unnecessary, the process proceeds to step S204. On the other hand, if it is determined that it is necessary to transmit the relevant information (YES in step S2030), the process proceeds to step S2032.

In step S2032, process executing unit 206 transmits the relevant information via communication unit 660. When the relevant information is transmitted, it is determined in step S108 of the processes on a mobile terminal 500 side that the information is received from controlled device 600.

Next, a specific operation in the present modification will be described.

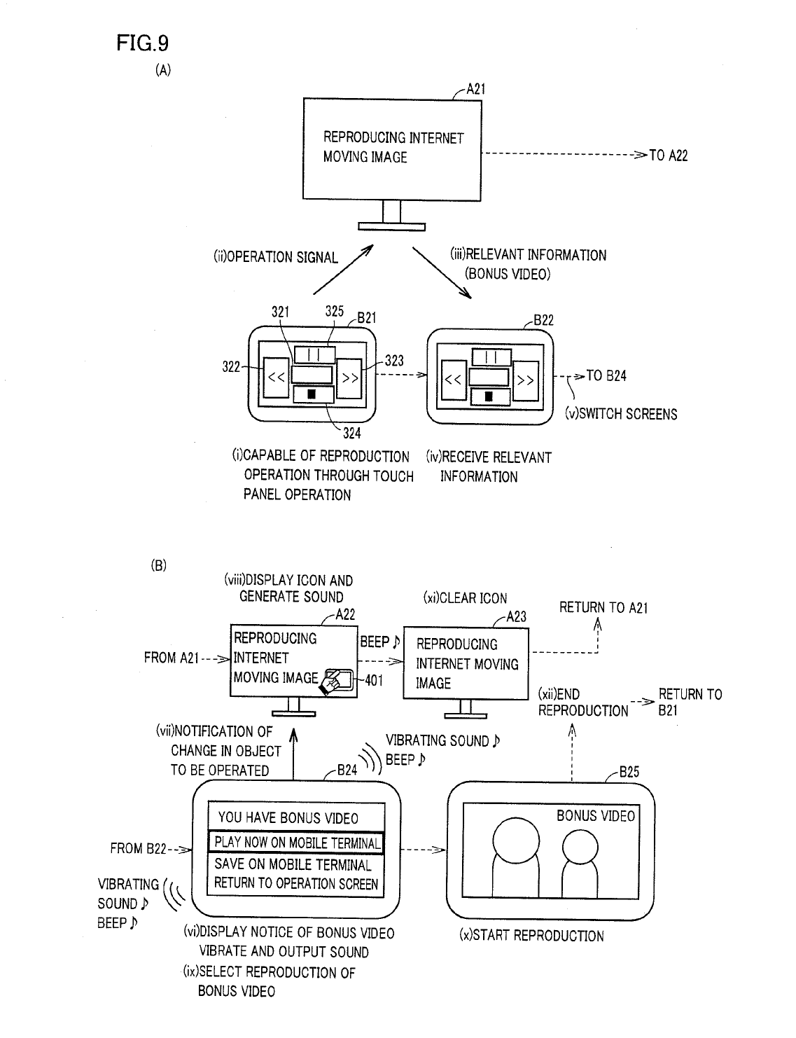

FIG. 9 shows a specific example of an operation executed by the control system of the first modification of the embodiment of the present invention.

In this example, controlled device 600 is envisioned to be an Internet-enabled television set. The scene envisioned is where a specific video (relevant information) is transmitted to mobile terminal 500 by push-type service while a moving image by Internet service is being viewed on the television set.

FIG. 9(A) shows examples of screens of mobile terminal 500 and controlled device 600 in the controlled-device operating mode. FIG. 9(B) shows examples of screens of mobile terminal 500 and controlled device 600 in the terminal-itself operating mode.

Referring to FIG. 9(A), initially displayed on mobile terminal 500 are a play button 321, a back button 322, a fast-forward button 323, a stop button 324, and a pause button 325, as shown in a screen B21.

A user can perform a reproduction operation through a touch panel operation on screen B21 (state (i)). When the user depresses any of the buttons, a corresponding operation signal is transmitted to controlled device 600 (state (ii)). On controlled device 600, an Internet moving image is being displayed as shown in a screen A21.

It is assumed that it is determined in controlled device 600 during the reproduction of the Internet moving image that there is a need to transmit relevant information (step S2030). For instance, it is assumed that there is a bonus video (an example of relevant information) related to the moving image being reproduced. The bonus video is one that is transmitted to mobile terminal 500 by way of the television set (controlled device 600) independently of an operation by the user.

In that case, as a state (iii), the relevant information is transmitted to mobile terminal 500 (step S2032).

Mobile terminal 500 receives the relevant information (state (iv)). Then, the display on mobile terminal 500 is switched from an existing screen B22 to a screen like a screen B24 in FIG. 9(B) (state (v)).

Receiving the relevant information, mobile terminal 500 displays a notice of bonus video as shown in screen B24 while vibrating and outputting sound (state (vi)). At the same time, mobile terminal 500 notifies controlled device 600 of a change in object to be operated (state (vii)).

Controlled device 600 displays a predetermined icon 401, as shown in a screen A22, and outputs sound (state (viii)).

It is assumed that at mobile terminal 500, reproduction of the bonus video is selected by the user (state (ix)). Then, reproduction of the bonus video is started on mobile terminal 500, as shown in a screen B25 (state (x)).

At controlled device 600, if it is determined that a predetermined period of time has passed since icon 401 was displayed, icon 401 is cleared as shown in a screen A23 (state (xi)).

Subsequently, reproduction of the bonus video is ended (state (xii)). Then, display unit 530 of mobile terminal 500 again displays, for example, the buttons for remotely operating controlled device 600, as screen B21 in FIG. 9(A).

As described above, even in a case where particular information is transmitted from controlled device 600 independently of an operation through mobile terminal 500 by a user him/herself as in the first modification of the present embodiment, it is possible to notify the user of a change in operating mode. As a result, the present modification can also provide the same effects as those in the above-described embodiment. It is noted that the same applies not only to the case where controlled device 600 autonomously transmits particular information, but also to a case where an operation through remote controller 300 causes controlled device 600 to transmit particular information.

It is noted that the embodiment above and the first modification may be combined with each other.

<Second Modification>

In the embodiment above and the first modification thereof, two-way communication is performed between the mobile terminal and the controlled device. However, a system in which one-way communication is performed from the mobile terminal to the controlled device may also be possible. Such a form will be described as a second modification of the embodiment of the present invention.

It is noted that the configuration and basic operation of this control system are the same as those in the embodiment above. Therefore, descriptions will be given hereinafter only on differences from the embodiment above.

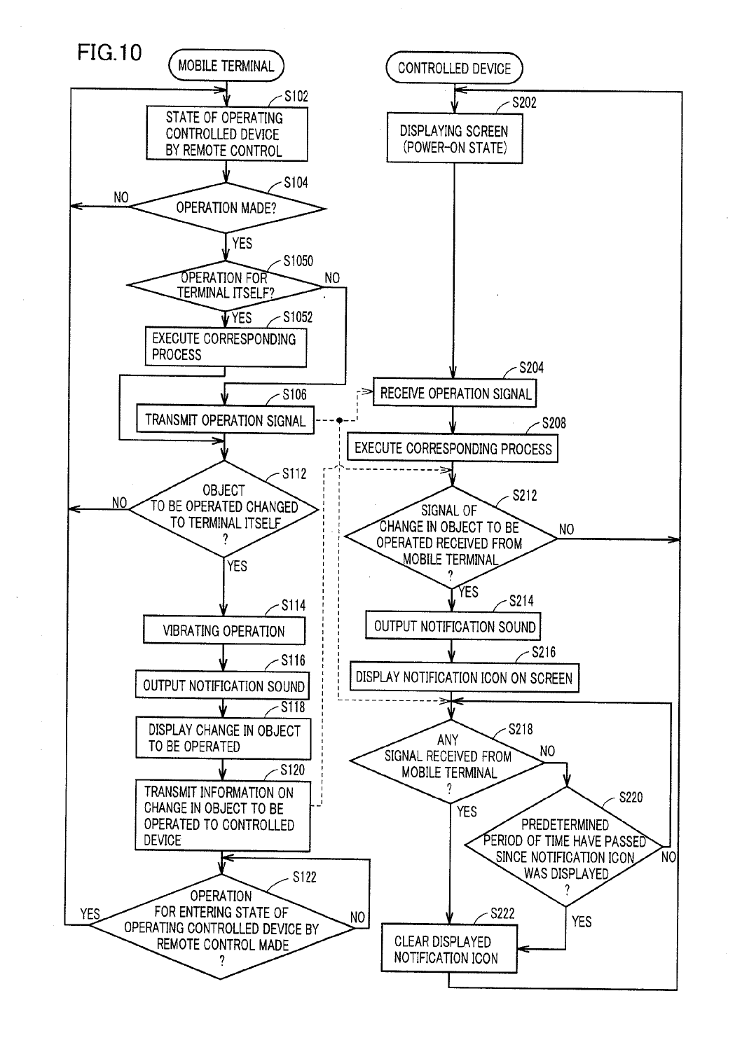

FIG. 10 is a flowchart showing the operation of the control system in the second modification of the embodiment of the present.

Referring to FIG. 10, as compared to the flowchart for the embodiment, processes of steps S1050 and S1052 are interposed between steps S104 and S106 in the processes on a mobile terminal 500 side. Further, on a controlled device 600 side, the processes of steps S206 and S210 are eliminated. Other processes are the same as those in the embodiment.

In step S1050, instruction determining unit 108 determines whether or not an instruction signal accepted from input unit 100 indicates an operation for the terminal itself. In the present modification, buttons of input unit 100 during the controlled-device operating mode include a special button for instructing a process in the terminal itself.

If it does not indicate an operation for the terminal itself (NO in step S1050), the process proceeds to step S106. In contrast, if a user gives an instruction through the above-described special button and it is determined as indicating an operation for the terminal itself (YES in step S1050), the process proceeds to step S1052.

In step S1052, process executing unit 110 executes a process corresponding to the specifics of the instruction. Further, since it is an operation for the terminal itself, instruction determining unit 108 sets the mode identification flag in mode storage unit 112 to 1 and rewrites the mode information. After this process, the process moves to step S112.

In the present modification, step S106 is not followed by step S108 (determining whether or not information is received from controlled device 600) and step S110 (processing received information), and the process proceeds to step S112.

It is noted that if it was determined in step S1050 that an operation for the terminal itself is made (YES in step S1050) and thus the process has moved to step S112, change determining unit 102 always determines that an object to be operated is changed to the terminal itself.

Although the flowchart in FIG. 10 illustrates that the corresponding process is executed in step S1052 before a process of moving to step S112 is performed, actually, the process of step S1052 and the processes of steps S112 to S120 may be performed in parallel.

Further, even if it is does not indicate an operation for the terminal itself (NO in step S1050), the mode identification flag in mode storage unit 112 may be set to 1, and the mode information may be rewritten.

Next, a specific operation in the present modification will be described.

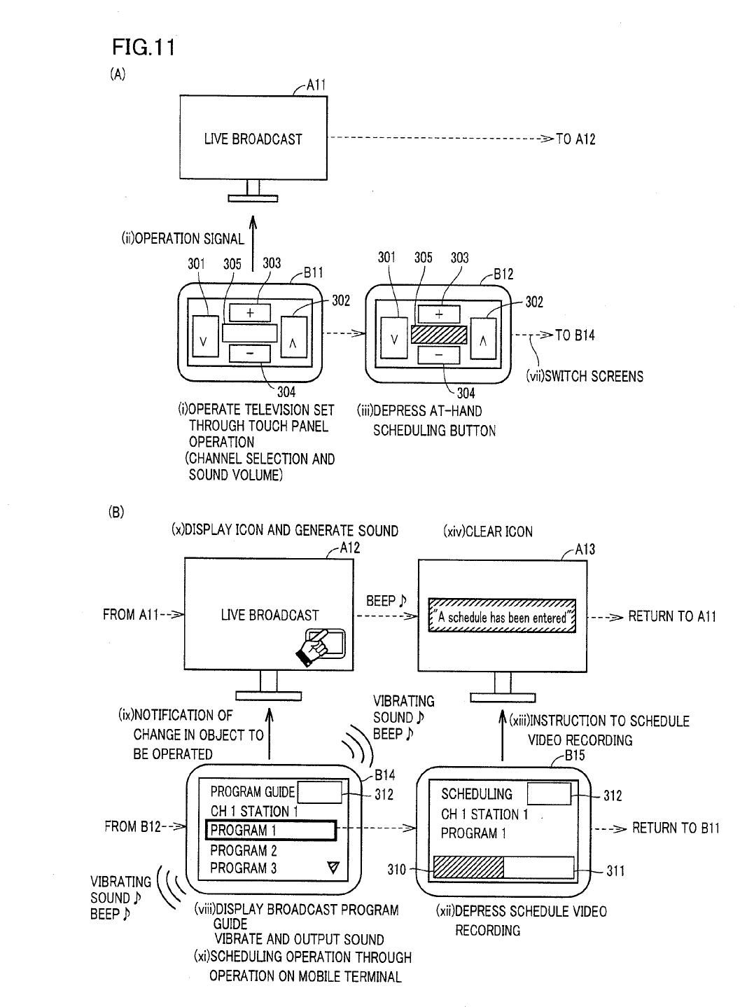

FIG. 11 shows a specific example of an operation executed by the control system in the second modification of the embodiment of the present invention.

Also in this example, controlled device 600 is envisioned to be a television set. The scene envisioned is, as in the embodiment above, where a user using mobile terminal 500 as a remote controller wishes to check a broadcast program guide to schedule a video recording while viewing a live television broadcast without cluttering the screen (without displaying information other than the live broadcast).

FIG. 11(A) shows examples of screens of mobile terminal 500 and controlled device 600 in the terminal-itself operating mode. FIG. 11(B) shows examples of screens of mobile terminal 500 and controlled device 600 in the controlled-device operating mode.

Referring to FIG. 11(A), as compared to FIG. 7(A) used for the embodiment above, they are identical with each other from state (i) to state (iii). At-hand-scheduling button 305 in the present modification is a special button (which does not transmits any signal to the television set) for accepting an instruction to display a broadcast program guide on mobile terminal 500.

In the present embodiment, obtaining a broadcast program is performed within the terminal itself, and therefore, the processes and operations of states (iv) to (vi) in the embodiment are not performed.

FIG. 11(B) is the same as FIG. 7(B). Description of each state shown in FIG. 11(B) will not be repeated.

As described above, even with a mobile terminal which performs only one-way communication to the controlled device, if a shift to the terminal-itself operating mode is made during the controlled-device operating mode, a notification of a change in object to be operated can be provided by vibration and/or sound. As a result, the present modification can also provide the same effects as those in the above-described embodiment.

It is noted that in the present modification, description was given on an example in which an operation by the user triggers a change in operating mode; however, this is non-restrictive. For example, it is applicable to a case where the operating mode is changed regardless of an operation by a user, such as a switch between screens made by a scheduler. Further, mobile terminal 500 may be configured to change the operating mode of mobile terminal 500 based on a receipt by mobile terminal 500 of a signal and/or data transmitted from another equipment except mobile terminal 500 and controlled device 600. Examples of such another equipment include a server device on the Internet.

In the embodiment above and the modifications thereof, the mode identification flag is changed if process executing unit 110 of mobile terminal 500 receives particular information from controlled device 600, or the mode identification flag is changed if instruction determining unit 108 determines that the special button (a button for instructing a process for the terminal itself) is operated by the user. However, such a determination of a mode change based on a (single) mode identification flag is non-restrictive.

For instance, a plurality of mode identification flags may be prepared associated with respective data of a plurality of terminal screens to be displayed on mobile terminal 500. Then, mobile terminal 500 may monitor the current mode and determines, at the timing of when the state (terminal screen) changes, whether or not a mode change is made.

Alternatively, a determination using the mode identification flag is non-restrictive. For instance, it may be checked whether or not any of the responses (actions) corresponding respectively to all button operations of input unit 100 is defined as transmission of a control signal (remote control signal), and if there is no such definition, the terminal-itself operating mode may be determined.

Further, a control method performed by the mobile terminal and by the controlled device of the present invention can also be provided as a program. Such a program can be provided as a program product recorded on a computer-readable recording medium, for example, an optical medium such as a CD-ROM (Compact Disc-Read Only Memory), and a memory card. Further, the program can be provided by downloading via a network.

It is noted that the program according to the present invention may cause the process to be executed by invoking a necessary module among program modules offered as part of an operating system (OS) of a computer, in a predetermined sequence at a predetermined timing. In that case, the program itself does not include the above-described module, but the process is executed in cooperation with the OS. Such a program not including a module could also be covered by the program according to the present invention.

Further, the program according to the present invention may be offered as incorporated into part of another program. Also in such a case, the program itself does not include the module included in the above-described other program, and the process is executed in cooperation with the other program. Such a program incorporated into another program could also be covered by the program according to the present invention.

An offered program product is installed in a program storage unit, such as a hard disk, and is executed. It is noted that the program product includes a program itself and a storage medium in which the program is stored.

It should be understood that the embodiment disclosed herein is illustrative and non-restrictive in every respect. The scope of the present invention is defined by the terms of the claims, and is intended to include all modifications within the meaning and scope equivalent to the terms of the claims.

### REFERENCE SIGNS LIST

60 telephone network; 70 network; 100 input unit; 102 change determining unit; 106 informing process unit; 108 instruction determining unit; 110 process executing unit; 112 mode storage unit; 114 assignment storage unit; 180, 180A program; 202 signal determining unit; 204 informing process unit; 206 process executing unit; 300 remote controller; 500 mobile terminal; 510 control unit; 520 storage unit; 522 temporary storage unit; 530 display unit; 532 VDP; 536 VRAM; 540 operation unit; 550 recording medium access unit; 550A recording medium insertion unit; 555 recording medium; 560, 562, 566 communication unit; 564 antenna; 570, 572 audio output unit; 574 audio input unit; 575 buzzer; 576 LED; 578 image capturing unit; 579 vibration unit; 600 controlled device; 602 antenna; 605 tuner; 607 data processing unit; 610 control unit; 620 storage unit; 622 temporary storage unit; 630 display unit; 632 VDP; 636 VRAM; 640 operation unit; 660, 662 communication unit; 670 audio output unit; 675 buzzer; 679 timer unit; 680 RC signal receiving unit; 1000 control system.

1. A control system comprising:
a mobile terminal device; and
a controlled device capable of communicating with said mobile terminal device, said mobile terminal device including:
an input unit for accepting an instruction;
a first determining unit for determining specifics of an instruction based on a signal from said input unit, according to a current operating mode of either a first mode controlling said controlled device or a second mode performing a process for said mobile terminal device;
a first communication unit for transmitting a control signal corresponding to determined specifics of an instruction, to said controlled device when in said first mode;
a first process executing unit for executing a process corresponding to determined specifics of an instruction when in said second mode;
a second determining unit for determining whether or not the operating mode is changed from said first mode to said second mode;
an informing process unit for performing a process of informing of a change in operating mode if it is determined that a change in operating mode is made; and
a first output unit for outputting at least one of vibration, light, and sound according to a process by said informing process unit,
said controlled device including:
a second communication unit for receiving said control signal from said first communication unit; and
a second process executing unit for executing a process corresponding to received said control signal.

2. The control system according to claim 1, wherein
said second communication unit further transmits particular information to said mobile terminal device,
said first communication unit further receives said particular information,
said first process executing unit further processes said particular information received by said first communication unit, and
said second determining unit determines that the operating mode is changed to said second mode if said particular information is received.

3. The control system according to claim 2, wherein
said controlled device further includes a third determining unit for determining whether or not said control signal received by said second communication unit is an instruction to transmit said particular information, and
said second process executing unit executes a process of transmitting said particular information from said second communication unit to said mobile terminal device if it is determined that said control signal is an instruction to transmit said particular information.

4. The control system according to claim 1, wherein
said informing process unit further performs a process of transmitting a change signal indicating a change in object to be operated, from said first communication unit to said controlled device if it is determined by said second determining unit that a change in operating mode is made,
said controlled device further includes:
an informing process unit for performing a process of informing that the operating mode in said mobile terminal device is changed to said second mode if said change signal is received; and
a second output unit for outputting predetermined information according to a process by said informing process unit.

5. A mobile terminal device capable of communicating with a controlled device performing a process corresponding to a received control signal, comprising:
an input unit for accepting an instruction;
a first determining unit for determining specifics of an instruction based on a signal from said input unit, according to a current operating mode of either a first mode controlling said controlled device or a second mode performing a process for said mobile terminal device;
a communication unit for transmitting a control signal corresponding to determined specifics of an instruction, to said controlled device when in said first mode;
a process executing unit for executing a process corresponding to determined specifics of an instruction when in said second mode;
a second determining unit for determining whether or not the operating mode is changed from said first mode to said second mode;
an informing process unit for performing a process of informing of a change in operating mode if it is determined that a change in operating mode is made; and
an output unit for outputting at least one of vibration, light, and sound according to a process by said informing process unit.

6. The mobile terminal device according to claim 5, wherein
said communication unit further receives particular information from said controlled device,
said process executing unit further processes said particular information received by said communication unit, and
said second determining unit determines that the operating mode is changed to said second mode if said particular information is received.

7. The mobile terminal device according to claim 5, wherein
said informing process unit further performs a process of transmitting a change signal indicating a change in object to be operated, from said communication unit to said controlled device if it is determined by said second determining unit that a change in operating mode is made.

8. A controlled device capable of communicating with a mobile terminal device, said mobile terminal device determining whether or not an operating mode in said mobile terminal device is changed from a first mode controlling said controlled device to a second mode performing a process for said mobile terminal device, and transmitting a change signal indicating a change in object to be operated, to said controlled device if it is determined that a change in operating mode is made, the controlled device comprising:
a communication unit for receiving a control signal and said change signal from said mobile terminal device;
a process executing unit for executing a process corresponding to said control signal if said control signal is received;
an informing process unit for performing a process of informing that the operating mode in said mobile terminal device is changed to said second mode if said change signal is received; and
an output unit for outputting predetermined information according to a process by said informing process unit.

9. The controlled device according to claim 8, wherein
said output unit includes a display unit for displaying said predetermined information.

10. A control method for controlling a mobile terminal device capable of communicating with a controlled device performing a process corresponding to a received control signal, comprising the steps of:
accepting an instruction signal;
determining specifics of an instruction indicated by said instruction signal, according to a current operating mode of either a first mode controlling said controlled device or a second mode performing a process for said mobile terminal device;
transmitting a control signal corresponding to determined specifics of an instruction, to said controlled device when in said first mode;
executing a process corresponding to determined specifics of an instruction when in said second mode;
determining whether or not the operating mode is changed from said first mode to said second mode; and
informing of a change in operating mode by at least one of vibration, light, and sound if it is determined that a change in operating mode is made.

11. A control method for controlling a controlled device capable of communicating with a mobile terminal device, said mobile terminal device determining whether or not an operating mode in said mobile terminal device is changed from a first mode controlling said controlled device to a second mode performing a process for said mobile terminal device, and transmitting a change signal indicating a change in object to be operated, to said controlled device if it is determined that a change in operating mode is made, the control method comprising the steps of:
receiving a control signal and said change signal from said mobile terminal device;
executing a process corresponding to said control signal if said control signal is received; and
informing that the operating mode in said mobile terminal device is changed to said second mode if said change signal is received.

12. A computer-readable non-transitory recording medium storing a control program for controlling a mobile terminal device capable of communicating with a controlled device performing a process corresponding to a received control signal, said control program causing said mobile terminal device to perform the steps of:
accepting an instruction signal;
determining specifics of an instruction indicated by said instruction signal, according to a current operating mode of either a first mode controlling said controlled device or a second mode performing a process for said mobile terminal device;
transmitting a control signal corresponding to determined specifics of an instruction, to said controlled device when in said first mode;
executing a process corresponding to determined specifics of an instruction when in said second mode;
determining whether or not the operating mode is changed from said first mode to said second mode; and
informing of a change in operating mode by at least one of vibration, light, and sound if it is determined that a change in operating mode is made.

13. A computer-readable non-transitory recording medium storing a control program for controlling a controlled device capable of communicating with a mobile terminal device, said mobile terminal device determining whether or not an operating mode in said mobile terminal device is changed from a first mode controlling said controlled device to a second mode performing a process for said mobile terminal device, and transmitting a change signal indicating a change in object to be operated, to said controlled device if it is determined that a change in operating mode is made, said control program causing said controlled device to perform the steps of:
receiving a control signal and said change signal from said mobile terminal device;
executing a process corresponding to said control signal if said control signal is received; and
informing that the operating mode in said mobile terminal device is changed to said second mode if said change signal is received.
